(19) United States
(12) Patent Application Publication
(10) Pub. No.: US 2015/0239718 A1
(43) Pub. Date: Aug. 27, 2015

(54) REACHING LOADER

(71) Applicant: PETTIBONE/TRAVERSE LIFT, LLC., Baraga, MI (US)

(72) Inventors: Philip E. LaTendresse, Chassell, MI (US); Daniel P. Toutant, Dollar Bay, MI (US)

(73) Assignee: PETTIBONE/TRAVERSE LIFT, LLC., Baraga, MI (US)

(21) Appl. No.: 14/626,174

(22) Filed: Feb. 19, 2015

Related U.S. Application Data
(60) Provisional application No. 61/943,119, filed on Feb. 21, 2014.

(51) Int. Cl. B66F 9/065; B66F 9/22; B66F 9/075

(52) U.S. Cl. CPC B66F 9/065; B66F 9/0759; B66F 9/22

(57) ABSTRACT

A reaching loader includes a vehicle chassis and cab in which a vehicle operator is disposed. The loader may comprise a boom having front and rear portions and an elbow portion therebetween and a pair of fascia portions extending downward from a roof portion. A pair of lift cylinders having upper and lower ends may be provided, wherein the lower ends are pivotably mounted to the vehicle chassis and the upper ends are pivotably mounted to the elbow portion of the boom. In one embodiment, the fascia portions extend at least partially below an upper surface of the cab.

### PRIORITY CLAIM

This invention claims the benefit of priority of U.S. Provisional Application Ser. No. 61/943,119, entitled “Reaching Loader,” filed Feb. 21, 2014, the disclosure of which is hereby incorporated by reference in its entirety.

### BACKGROUND

Material handling devices with reaching booms, commonly referred to as reaching loaders, have been used in different capacities. Reaching loaders can include a steerable and drivable wheeled vehicle with a cab in which an operator can be positioned for operating and manipulating the vehicle and the reaching boom.

Traditional reaching loaders include a moveable boom with a mounted tool, such as a fork, a baler, a clam, or the like, that can be manipulated to handle a target material or payload.

The reaching boom can be manipulated through the use of hydraulic cylinder assemblies that are connected to the reaching boom and associated linkages.

While traditional reaching loaders are known in the art to an extent, improvements can be made in various areas.

### SUMMARY

In one embodiment, a reaching loader includes a material handling device including a vehicle chassis defining a fore-and-aft axis, and a cab portion attached to the vehicle chassis in which an operator can be disposed. The loader may comprise a linkage frame having upper and lower ends, the lower end pivotably mounted to a rear portion of the vehicle chassis. The loader may further comprise a boom having front and rear portions and an elbow portion therebetween and a pair of fascia portions extending downward from a roof portion, wherein the boom has a generally bent shape and the rear portion of the boom is pivotably mounted to the upper portion of the linkage frame.

A pair of lift cylinders having upper and lower ends may be provided, wherein the lower ends are pivotably mounted to the vehicle chassis and the upper ends are pivotably mounted to the elbow portion of the boom. A pair of reach cylinders may be employed having front and rear ends, wherein the rear ends are pivotably mounted to the chassis and the front ends are pivotably mounted to the linkage frame. In one embodiment, the fascia portions extend at least partially below an upper surface of the cab.

Other systems, methods, features and advantages of the invention will be, or will become, apparent to one with skill in the art upon examination of the following figures and detailed description. It is intended that all such additional systems, methods, features and advantages be within the scope of the invention, and be encompassed by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is an isometric view of a reaching loader having a chassis, cab, boom, and linkage frame, where the linkage frame and boom are adjustable relative to the chassis;

FIG. 2 is a rear view of the reaching loader;

FIG. 3 is a front view of the reaching loader;

FIG. 4 is a left side view of the reaching loader;

FIG. 5 is a top view of the reaching loader;

FIG. 6 is a bottom view of the reaching loader;

FIG. 7 is an isometric view of a portion of the reaching loader, with certain components removed for clarity;

FIG. 8 is a left side view of the reaching loader with certain components removed for clarity;

FIG. 9 is a left side of the reaching loader with the boom in a lift state actuated by extension of lift cylinders pivotably connected to the chassis and boom;

FIG. 10 is a left side of the reaching loader with the boom and linkage frame in a reach state, actuated by extension of reach cylinders pivotably connected to the chassis and linkage frame;

FIG. 11 is a left side view of the reaching loader in the reach state and further illustrating the cab in forward translated position;

FIG. 12 is a front view of the boom; and

FIG. 13 is a cross-sectional view of the boom of FIG. 12.

### DETAILED DESCRIPTION OF THE PREFERRED EMBODIMENTS

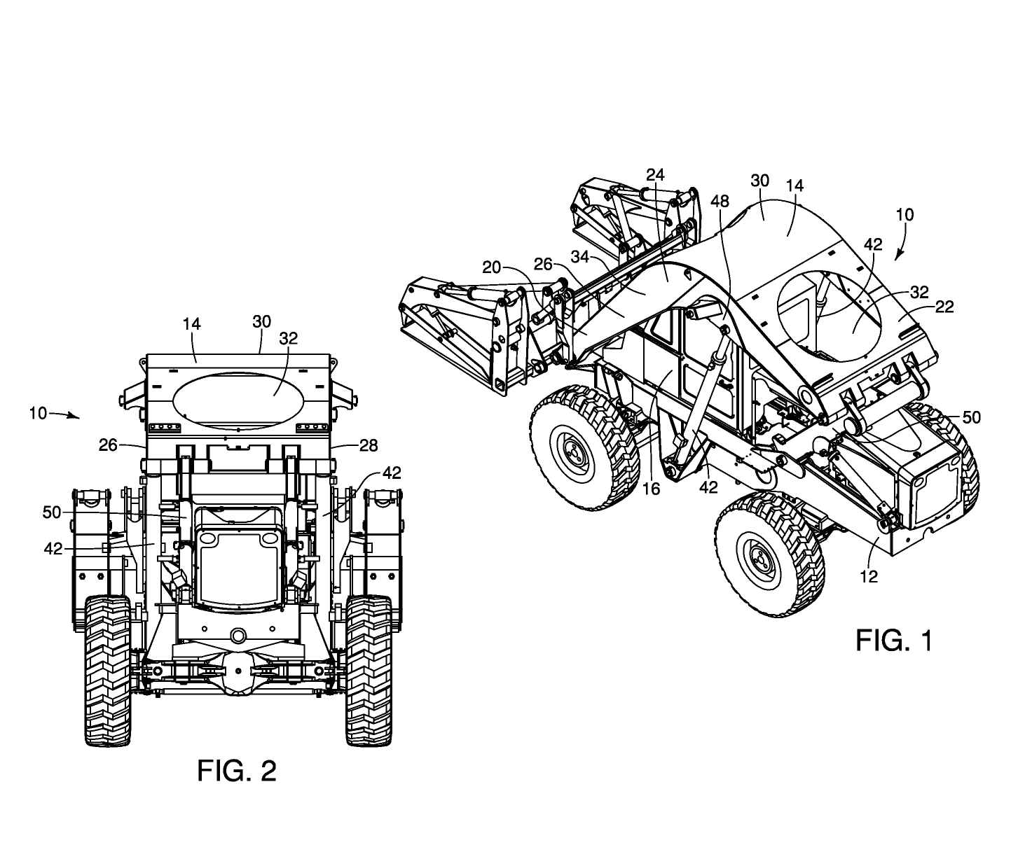

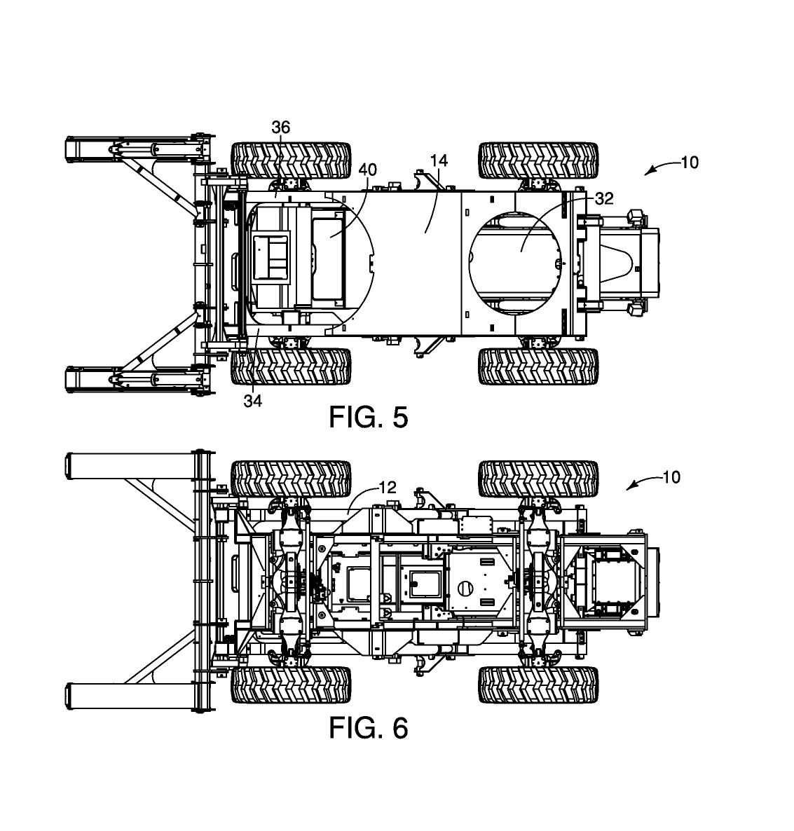

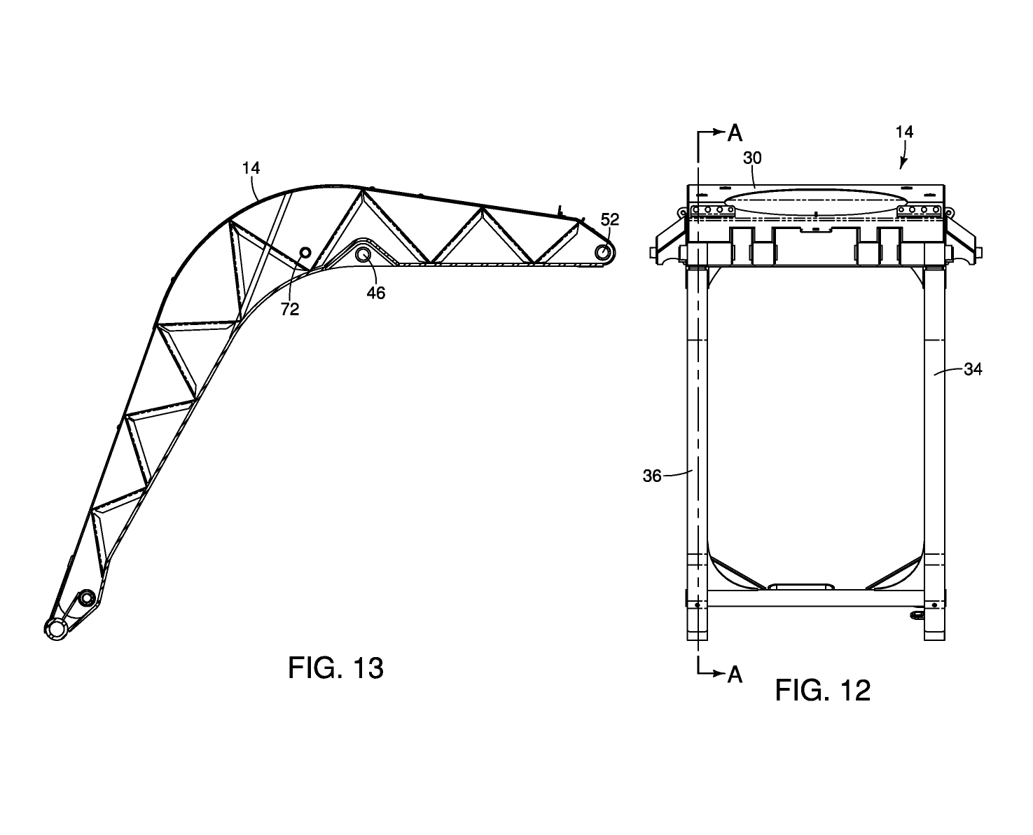

With reference to FIGS. 1-13, a material handling device in the form of a reaching loader 10 includes a vehicle chassis 12. A boom 14 is positioned generally above the chassis 12 and is moveable relative to the chassis 12 to manipulate target material or payload as desired by an operator. The chassis 12 includes a cab portion 16 in which the operator can be disposed for operating the loader 10.

The loader 10 includes a fore-and-aft axis defined by the longitudinal center of the vehicle. Accordingly, the loader 10 includes a front and a rear. References to the front, or front portions, will refer to components or portions of components that are relatively toward the front of the loader, and references to the rear will refer to the components or portions of components that located relatively toward the rear of the loader 10.

Similarly, the loader 10 can include a side-to-side axis that is generally perpendicular to the fore-and-aft axis. Accordingly, the references to “left” and “right” components or portions of components will refer to components on the left or right side, respectively, of the fore-and-aft axis as viewed from the rear.

The boom 14 is ultimately connected to the chassis 12 by a variety of components, described in further detail below. The boom 14 has a generally bent or curved shape when viewed from the side of the loader 10, for example as shown in the left side view of FIG. 4. More particularly, the boom 14 includes a front portion 20, a rear portion 22, and an elbow portion 24 located longitudinally between the front and rear portions 20, 22.

The boom 14 includes a left fascia portion 26 that extends from the rear portion 22 to the front portion 20. Similarly, the boom includes a right fascia portion 28 that extends from the rear portion 22 to the front portion 20.

The left and right fascia portions 26, 28 extend generally down from an upper roof portion 30. In one embodiment, the upper roof portion 30 extends from the rear portion 22 to the elbow portion 24, though it may have segments disposed front or rear of the elbow portion 24. The roof portion 30 can include a rear opening 32 therethrough.

The boom 14 further includes left and right arms 34, 36 that extend forward from the roof portion 30. The left and right arms 34, 36 are partially formed by the left and right fascia portions 26, 28.

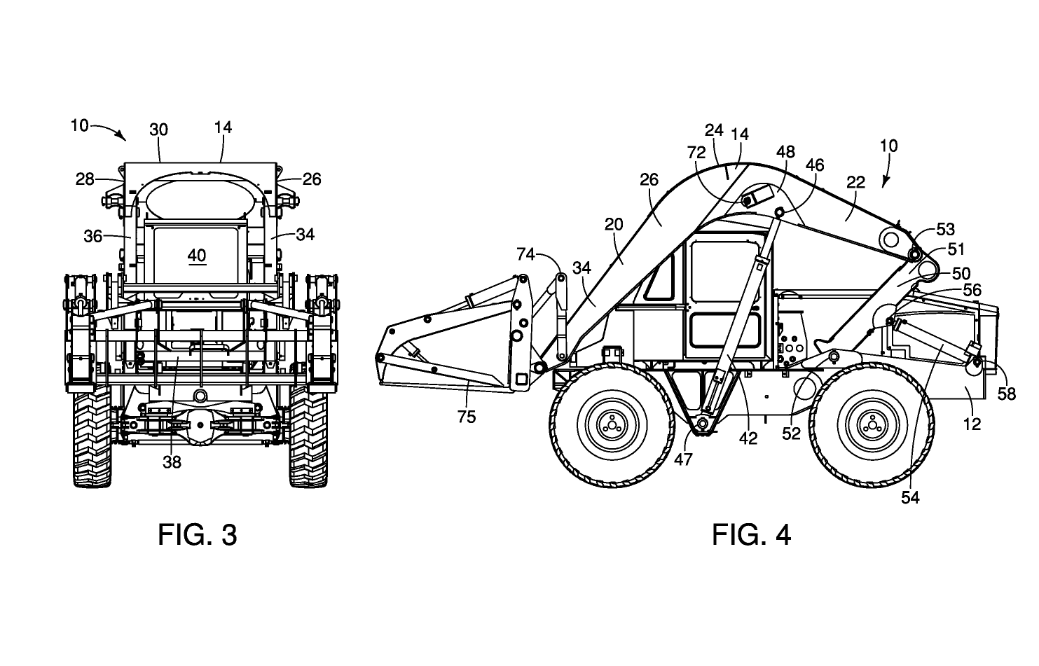

The left and right arms 34, 36 can be connected at the front ends thereof by a support beam 38, as shown in FIG. 3. Thus, the left and right arms 34, 36, the support beam 38, and the front of the roof portion 30 can define a frontal opening 40.

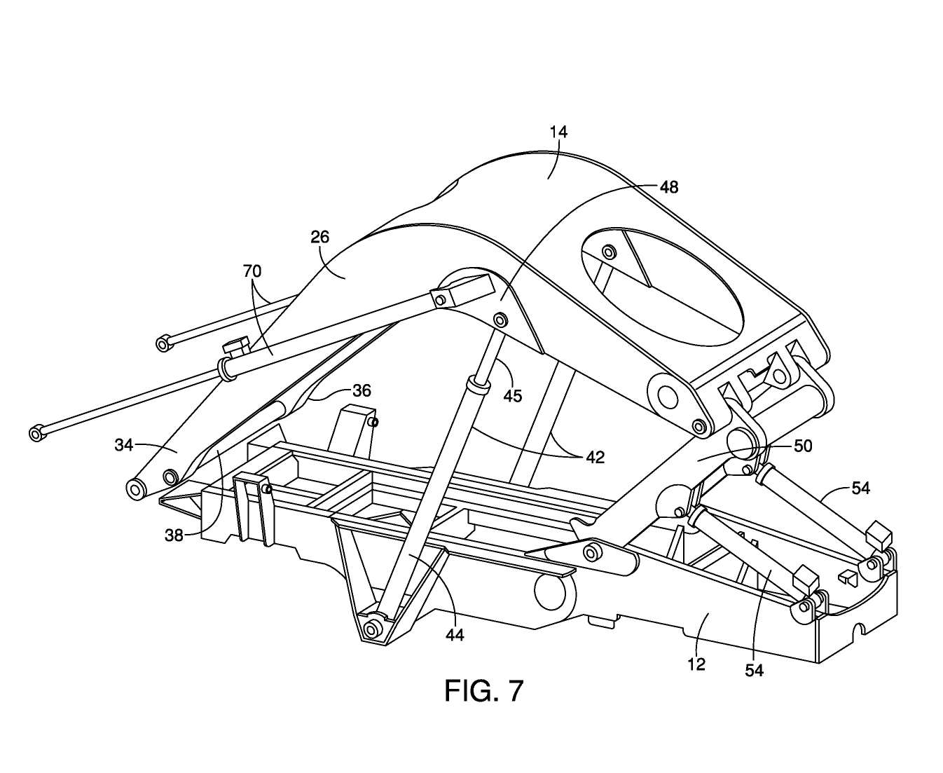

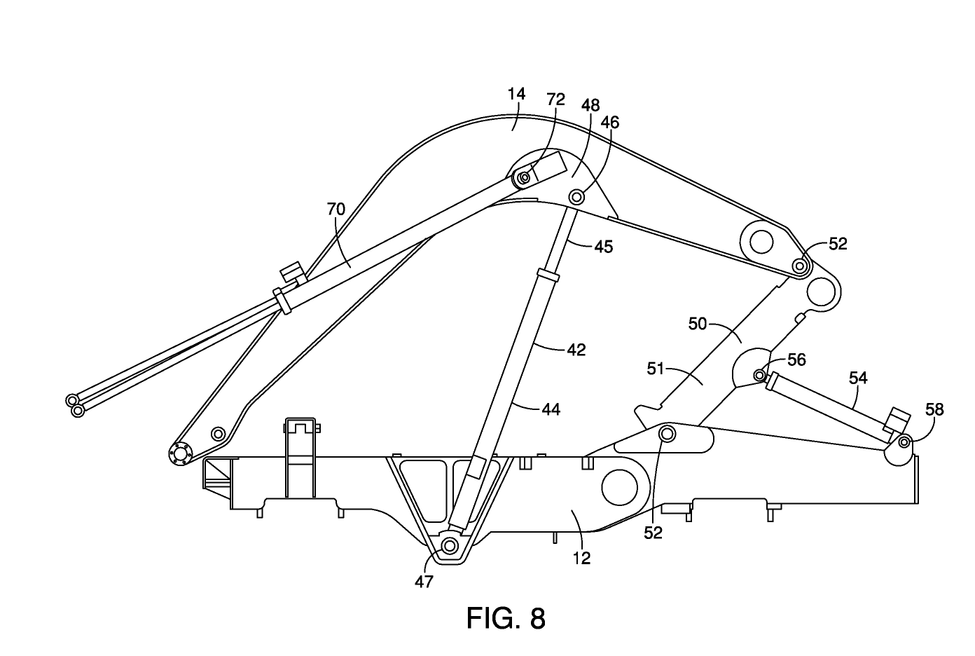

The boom 14 can be connected to the chassis 12 by a pair of hydraulic cylinder assemblies or lift cylinders 42 disposed on the left and right sides of the chassis. The lift cylinders 42 include a housing 44 and extendable shaft 45, noted in FIGS. 7-8, which is extendable and retractable therefrom. An upper end of the shaft 45 is pivotably connected to the elbow portion 24 of the boom 14 at a pivot axis 46, while a lower end of the housing 44 is pivotably mounted to the vehicle chassis 12 at a pivot axis 47, as best seen in FIG. 4.

References to hydraulics can also refer to other known methods such as pneumatics, other fluids, gases, or the like.

The upper end of each of the shafts 45 is mounted to the elbow portion 24 at a reinforcement portion 48 of each of the left and right fascia portions 26, 28. The reinforcement portion 48 is generally thicker than adjacent areas of the fascia portion 26, 28. The reinforcement portion 48 may be integrally formed with, or externally coupled to, the fascia portion 26, 28.

In one approach, each of the lift cylinders 42 are generally laterally aligned with each of the left and right fascia portions 26, 28 of the boom 14, and more particularly, are laterally aligned with the reinforcement portions 48. Advantageously, the structural integrity of the boom 14 in the area of the fascia portions 26, 28 is significantly enhanced.

The rear end of the rear portion 22 of the boom 14 is connected to the chassis 12 via a linkage frame 50. The linkage frame 50 includes a top portion pivotably connected to the rear end of the boom 14. As best seen in FIG. 4, the linkage frame 50 is connected to the chassis 12 on both the left and right side of the chassis 12 via linkage arms 51 at a pivot axis 52. The pivot axis 52 is located above and rearward of the pivot axis 47. The linkage frame 50 is pivotably connected to the boom 14 at a pivot axis 53.

The linkage frame 50 is further connected to the chassis 12 via a pair of rear hydraulic cylinder assemblies or reach cylinders 54. The reach cylinders 54 are generally laterally aligned with the arms 51 of the linkage frame 50. The front ends of the reach cylinders 54 are pivotably connected to a middle portion of the arms 51 at a pivot axis 56, and the rear ends of the reach cylinders 54 are pivotably connected to the chassis 12 at a pivot axis 58. The pivot axis 58 is located generally rearward of the pivot axis 52.

Each of the above described pivot axes are in the lateral direction across the fore-and-aft axis of the vehicle. The axes 47, 52, and 58 are generally fixed relative to the vehicle chassis. The axes 46 and 56 are fixed to the boom 14 and linkage frame 50, respectively, but will translate relative to the chassis 12 during movement of the boom 14 and/or frame 50. The pivot axis 53 is fixed to both the boom 14 and the linkage frame 50 and will translate during movement of both the boom 14 and frame 50. During translation, the above described pivot axes will remain generally parallel to each other in a lateral direction to the chassis 12.

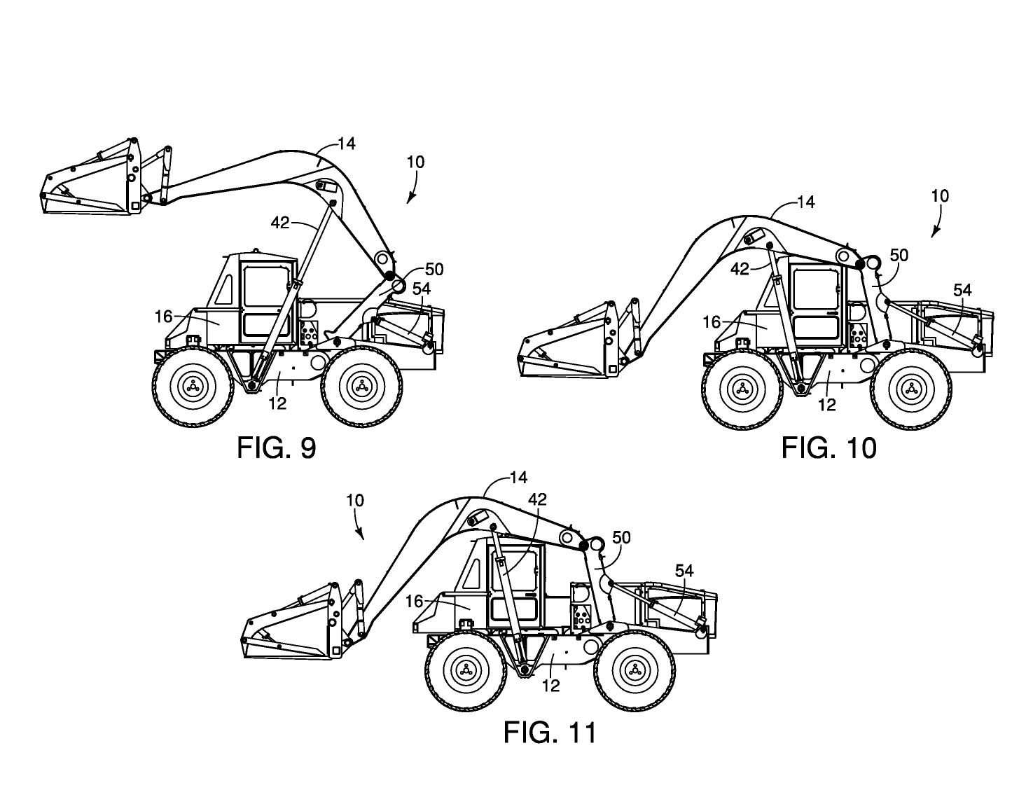

Extension of the lift cylinders 42 will cause the boom 14 to be generally lifted, as shown generally in FIG. 9, and retraction will cause the boom 14 to be generally lowered. Extension of the reach cylinders 54 will cause the linkage frame 50 to be moved relatively forward, which will in turn cause the boom 14 to be moved relatively forward, as shown generally in FIG. 10. Retraction of the reach cylinders 54 will cause the linkage bar 50, and in the turn the connected boom 14, to be moved relatively rearward. It will be appreciated that various combined extension and retraction conditions of the cylinders 42 and 54 can be used to more specifically adjust the position of the boom 14 and linkage frame 50. For instance, the loader 10 can both and reach and lift by extending the lift cylinders 42 and reach cylinders 54.

The chassis 12 further includes the cab 16 that is located generally above the chassis 12 and above the pivot axis 47. The cab 16 is also at least partially positioned below the boom 14. The cab 16 is also positioned laterally between the left and right fascia portions 26, 28. The left and right fascia portions 26, 28 are preferably sized and configured to extend below an upper portion of the cab 16, as shown in FIGS. 1 and 4. Because the cab is positioned between the fascia portions 26, 28, the boom 14 can extend lower than if the cab 16 extended below the fascia portions 26, 28.

The boom 14, having fascia portions 26, 28 rather than generally thicker arm portions, allows the cab 16 to have a greater lateral width while still allowing the boom 14 to extend downward, because the fascia portions 26, 28 can extend past the top of the cab 16 without interference.

Further, the lift cylinders 42 being generally laterally aligned with the fascia portions 26, 28 enables the fascia portions to be further laterally spaced relative to lift cylinders mounted outboard of a boom structure.

The cab 16 is also adjustable in the fore-and-aft direction relative to the chassis in a manner disclosed in U.S. Pat. No. 8,800,705, which is incorporated by reference herein in its entirety. For example, the cab 16 can be translated forward, as shown in FIG. 11.

The loader 10 can generally include pairs of front and rear wheels in a traditional four wheeled loader vehicle arrangement. The location of the pivotable connection between the linkage frame 50 and the chassis 12 can be preferably located generally above the rear wheels. Moreover, this pivotable connection can be preferably disposed inboard of the rear wheels, such that the front and rear wheels can be positioned longitudinally closer together to improve the turn radius and maneuverability of the loader relative to prior known loaders with linkage frame pivot points located in front of and/or laterally aligned with the rear wheels.

The loader 10 can also optionally include a pair of tilt cylinders 70 on both the left and right sides of the boom 14, as depicted in FIGS. 7-8. The rear end of the tilt cylinders 70 is pivotably connected to the boom 14 at axis 72, as shown in FIG. 8. The front end of the tilt cylinder 70 is pivotably connected at axis 74, defined in FIG. 4, to a tool member 75. Extension and retraction of the tilt cylinders 70 can manipulate the position and/or orientation of the tool 75 as desired by the user. It is noted that the tilt cylinders 70 are omitted in FIGS. 1-6 and 9-11 for illustrative clarity.

While various embodiments of the invention have been described, the invention is not to be restricted except in light of the attached claims and their equivalents. Moreover, the advantages described herein are not necessarily the only advantages of the invention and it is not necessarily expected that every embodiment of the invention will achieve all of the advantages described.

We claim:

1. A material handling device comprising:
a vehicle chassis defining a fore-and-aft axis;
a cab portion coupled to the vehicle chassis in which an operator can be disposed;
a linkage frame having upper and lower ends, the lower end pivotably mounted to a rear portion of the vehicle chassis;
a boom having front and rear portions and an elbow portion therebetween, and a pair of fascia portions extending downward from a roof portion, wherein the boom has a generally bent shape and the rear portion of the boom is pivotably mounted to the upper portion of the linkage frame; and
a pair of lift cylinders having upper and lower ends, wherein the lower ends are pivotably mounted to the vehicle chassis and the upper ends are pivotably mounted to the elbow portion of the boom,
wherein the fascia portions extend at least partially below an upper surface of the cab.

2. The material handling device of claim 1, wherein the pivotable connection between the linkage frame and the chassis is located generally above a pair of rear wheels.

3. The material handling device of claim 1, further comprising a pair of reach cylinders having front and rear ends, wherein the rear ends are pivotably mounted to the chassis and the front ends are pivotably mounted to the linkage frame.

4. The material handling device of claim 1, wherein the fascia portions include a reinforcement portion having a thickness greater than adjacent areas, and the lift cylinders are pivotably mounted to the reinforcement portions.

5. The material handling device of claim 1, wherein the pivotable connection between the linkage frame and the chassis is located generally inboard of a pair of rear wheels.

6. The material handling device of claim 1, wherein the lift cylinders are generally laterally aligned with the fascia portions.

7. A material handling device comprising:
a vehicle chassis defining a fore-and-aft axis;
a linkage frame having upper and lower ends, the lower end pivotably mounted to a rear portion of the vehicle chassis;
a boom having front and rear portions and an elbow portion therebetween and a pair of fascia portions extending downward from a roof portion, wherein the boom has a generally bent shape and the rear portion of the boom is pivotably mounted to the upper portion of the linkage frame; and
a pair of lift cylinders having upper and lower ends, wherein the lower ends are pivotably mounted to the vehicle chassis and the upper ends are pivotably mounted to the elbow portion of the boom,
wherein the fascia portions include a reinforcement portion having a thickness greater than adjacent areas, and the lift cylinders are pivotably mounted to the reinforcement portions.

8. The material handling device of claim 7, further comprising a pair of reach cylinders having front and rear ends, wherein the rear ends are pivotably mounted to the chassis and the front ends are pivotably mounted to the linkage frame;

9. The material handling device of claim 7, wherein the pivotable connection between the linkage frame and the chassis is located generally above a pair of rear wheels.

10. The material handling device of claim 7, wherein the pivotable connection between the linkage frame and the chassis is located generally inboard of a pair of rear wheels.

11. The material handling device of claim 7, wherein the lift cylinders are generally laterally aligned with the fascia portions.

12. The material handling device of claim 7 further comprising a cab mounted to the chassis, and wherein the fascia portions extend at least partially below an upper surface of the cab.
